(19) United States
(12) Patent Application Publication
(10) Pub. No.: US 2023/0115896 A1
(43) Pub. Date: Apr. 13, 2023

(54) SUPPLY CHAIN MANAGEMENT WITH SUPPLY SEGMENTATION

(71) Applicant: Dell Products L.P., Round Rock, TX (US)

(72) Inventors: Shibi Panikkar, Bangalore (IN); Rohit Gosain, Bangalore (IN); Ajay Maikhuri, Bangalore (IN)

(21) Appl. No.: 17/499,253

(22) Filed: Oct. 12, 2021

(51) Int. Cl. G06Q 10/08; G06Q 30/02

(52) U.S. Cl. CPC G06Q 10/0875; G06Q 30/0202

(57) ABSTRACT

Automated supply chain management techniques are disclosed. For example, a method comprises defining a plurality of supply segments to represent a forecasted demand for material needed to manufacture equipment via a supply chain, and allocating supplied material across one or more of the plurality of supply segments wherein a first portion of the supplied material is allocated in a non-fixed manner and a second portion of the supplied material is allocated in a fixed manner.

### FIELD

The field relates generally to information processing systems, and more particularly to supply chain management in such information processing systems.

### DESCRIPTION

Supply chain management in the manufacturing industry typically refers to the process of monitoring and taking actions required for the manufacturer, such as an original equipment manufacturer (OEM), to obtain raw materials, and convert those raw materials into a finished product that is then delivered to or otherwise deployed at a customer site. A goal of supply chain management is to adequately balance supply and demand, e.g., the supply of the raw material (the raw materials procured or otherwise acquired from vendors, etc.) with the demand of the raw materials (e.g., the raw materials needed to satisfy the manufacturing of equipment ordered by a customer). In the current manufacturing industry, the amount of raw material needed to be procured and stored is an ongoing issue for OEMs.

### SUMMARY

Illustrative embodiments provide automated supply chain management techniques in an information processing system.

For example, in an illustrative embodiment, a method comprises defining a plurality of supply segments to represent a forecasted demand for material needed to manufacture equipment via a supply chain, and allocating supplied material across one or more of the plurality of supply segments wherein a first portion of the supplied material is allocated in a non-fixed manner and a second portion of the supplied material is allocated in a fixed manner.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other illustrative embodiments include, without limitation, apparatus, systems, methods and computer program products comprising processor-readable storage media.

### BRIEF DESCRIPTION OF THE DRAWINGS

FIG. 1 depicts a demand segmentation example with which one or more illustrative embodiments can be implemented.

FIG. 2 depicts a supplier segmentation example with which one or more illustrative embodiments can be implemented.

FIG. 3 illustrates a supply chain management methodology with supply segmentation according to an illustrative embodiment.

FIG. 4 illustrates a soft allocation of inventory according to an illustrative embodiment.

FIG. 5 illustrates a hard allocation of inventory according to an illustrative embodiment.

FIG. 6 illustrates a supply chain management system architecture according to an illustrative embodiment.

FIG. 7 illustrates an example of a processing platform that may be utilized to implement at least a portion of an information processing system for supply chain management functionalities according to an illustrative embodiment.

### DETAILED DESCRIPTION

As mentioned above in the background section, the amount of raw material needed to be procured and stored is an ongoing issue for OEMs and other manufacturers. By way of example only, raw material (or simply, material) that is used to manufacture computing and/or storage equipment ordered by a customer via an OEM may include, but is not limited to, hard disk drives (HDDs), random access memory (RAM) modules, motherboards, etc.

In the current end-to-end planning processes, tools are available to classify the demand into various groups or buckets, e.g., retail orders, large orders, service level agreement (SLA) orders, run rate/transactional orders, etc. The current set of tools take the historical sales and provide the forecast with respect to the above segmented/bucketed demand. This segmentation is important as it helps sales representatives to load their forecasted numbers into the tool. Once the forecast process is completed, the tool provides the output with respect to the percentage of the given demand segments. This entire process is known in the industry as demand segmentation.

When it comes to the procurement processes, for example, an OEM gets the holistic number that the part/item owner tries to negotiate with the supplier. Once the supplier supplies the material of the corresponding quantity, it can either match the forecasted quantity or it can vary. If the supplied quantity is greater than or equal to the forecasted quantity, there are no challenges in distributing the supply into different demand segments. However, if the supplied quantity is less than the forecasted quantity, there is a challenge to distribute the supply among different demand segments.

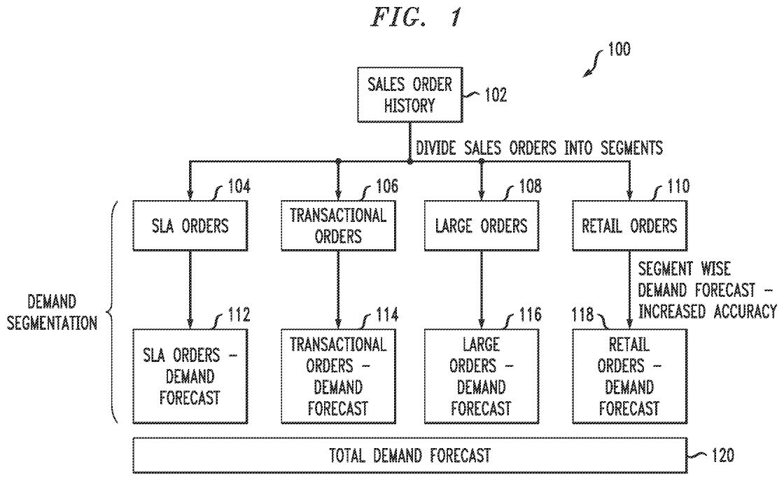

FIG. 1 depicts a demand segmentation example 100 with which one or more illustrative embodiments can be implemented. As shown, a sales order history 102 is segmented into SLA orders 104, transactional orders 106, large orders 108, and retail orders 110. Then, a demand forecast is generated for each segment, i.e., SLA orders demand forecast 112 for SLA orders 104, a transactional orders demand forecast 114 for transactional orders 106, a large orders demand forecast 116 for large orders 108, and a retail orders demand forecast 118 for retail orders 110. The separate demand forecasts 112, 114, 116 and 118 are aggregated into a total demand forecast 120.

By way of example, in the manufacturing supply chain environment of computing equipment (e.g., laptops servers, storage systems, etc.), a supply chain is typically driven by a demand segmentation model such as shown in example 100. The practice of analyzing demand data and dividing it into smaller segments helps measure performance or improve service levels. Demand segmentation analysis can be performed on pre-defined company segments, including products or locations. Demand segmentation analysis is effective when determining areas of improvement or analyzing a company's key performance indicators (KPIs). Even though demand segmentation may be used for different purposes in different industries, a main purpose is to increase the accuracy of demand forecasting. With demand segmentation, as illustrated in example 100, the demand from each segment is calculated separately and forecasted separately. Eventually the forecasted segment demands are aggregated into a total demand forecast (e.g., 120 in FIG. 1). Demand segmentation increases the demand forecasting since, for each segmentation, attributes for the demand forecasting will be different.

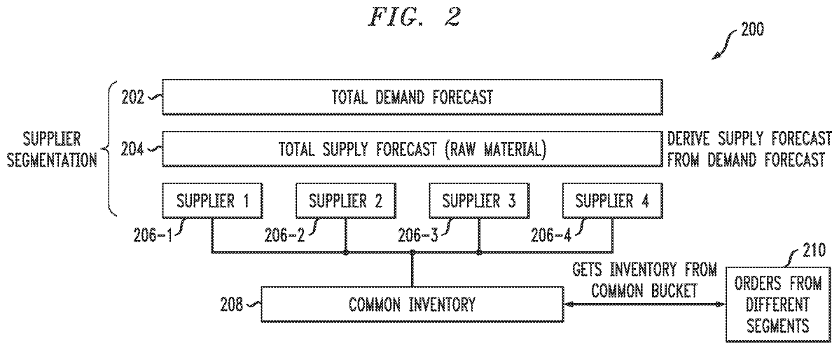

However, once the demand forecast is sent to a supplier according to a supplier segmentation model and the suppliers send the raw materials, the OEM typically maintains all raw materials (supply) in a single inventory bucket. Then, according to the order (e.g., transactional demand), the inventory from the common pool will get diminished to satisfy the need of the order. This is illustrated in FIG. 2 as a supplier segmentation example 200 with which one or more illustrative embodiments can be implemented.

As shown, a total demand forecast 202 (e.g., total demand forecast 120 in FIG. 1) is input and a total supply forecast 204 (the total raw materials needed for the total demand forecast) is derived from total demand forecast 202. A supplier segmentation model divides the suppliers of the raw material into supplier segments, i.e. supplier 206-1 (supplier 1), supplier 206-2 (supplier 2), supplier 206-3 (supplier 3), and supplier 206-4 (supplier 4). The raw material from each of the suppliers 206-1 through 206-4 is collectively maintained as a common inventory 208, which is diminished as orders from different demand segments 210 are satisfied.

Illustrative embodiments realize that, in manufacturing and other like industries, there is no such concept as supply segmentation due at least to the following reasons:

(i) Transactional orders can come in any segment, and the raw material supply for any segment could be drawn from common inventory.

(ii) If supply raw materials were segmented, there is a chance that one segment will get less transactional orders and others will get more. Then, for one segment, the raw material will be consumed quickly and face parts shortages, while the other segment will be stagnant for a long period.

Thus, in existing supply chain process, there is no enforcement to segment the raw material (supply). However in some OEM industries, where there are different customer segments and varieties of products (different models of laptops or servers using the same raw materials) and different sales models (e.g., need to deliver material in 14 days, perpetual sales with must arrive by dates (MABD), or sudden large order from an established or otherwise high priority customer), it is realized herein that the need of segmenting the supply into different segments is becoming more and more important to avoid the lower priority order consuming all raw material and leading to shortages of raw materials (parts shortages) for higher priority orders (e.g., for high valued customers).

OEMs are currently doing some level of manual inventory allocation for some high priority customers and orders based on experience and customer relationship. However, there is no systematic supply segmentation available in the supply chain management process.

Illustrative embodiments overcome the above and other drawbacks and deficiencies in existing supply chain management by defining and implementing supply segmentation (distinguished from supplier segmentation as illustrated above in the context of FIG. 2). For example, in some embodiments, supply segments can be defined as different combinations based on sales mode, customer relationship, type of customer, importance of order, size of order, and/or demand segmentation, where the supplied raw materials are segmented and soft allocated (i.e., can be re-allocated easily).

It is to be appreciated that soft allocation may be referred to herein as “non-fixed allocation” since it is intended to be subject to change, as compared with hard allocation which may be referred to herein as “fixed allocation” since it is intended to remain unchanged.

In contrast to demand segmentation, supply segmentation according to illustrative embodiments is not constant and rigid since supply segmentation may vary (e.g., adjusted many times in a day). Though supply segmentation may not totally eliminate parts shortages, it reduces the chance of parts shortages and improves the efficiency of the supply chain.

Further, illustrative embodiments provide for systematically creating a supply segmentation model, and soft allocating incoming supply and back logs based on the demand segmentation forecast percentage, and hard allocating the inventory for the high priority orders (e.g., largely eliminating parts shortages for high priority orders). Also, the soft allocation can be re-adjusted inside supply segments based on the change in the transactional demands and change in the incoming supply. This intelligent segmentation not only ensures systematic reduction in parts shortages for critical orders, but also gives a segment view to the supply so that the OEM can proactively take action for potential upcoming parts shortage scenarios.

Accordingly, supply chain management according to illustrative embodiments soft allocates (which can be changed multiple times according to the transactional orders) the incoming supply (raw material) for different types of order groups (supply segments). In some embodiments, supply segments are driven by one or more of: (i) historical consumption of raw material in different demand segments; (ii) customer relationship; (iii) level of urgency from customer; (iv) quotes and MABDs; (v) size of anticipated order; and (vi) type of order. Supply chain management according to illustrative embodiments can also hard allocate (not easily adjustable) some of the supply for different supply segments as per the need, re-adjust the soft allocation based on the transactional orders in a frequent time manner, and at the time of quote or order placement, provide procurement teams with visibility as to where the parts shortage can come to enable them to take action to replenish the raw material from a supplier in time.

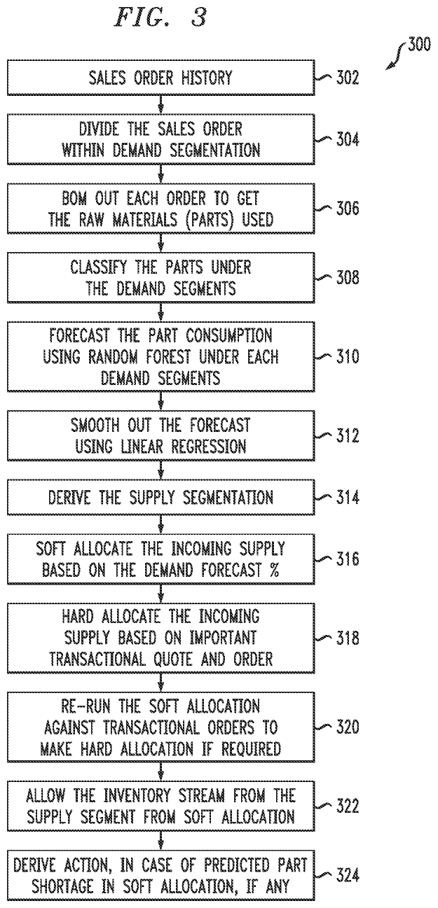

FIG. 3 illustrates a supply chain management methodology 300 with supply segmentation according to an illustrative embodiment. As shown, step 302 inputs a sales order history and step 304 divides the historical sales order based on a given demand segmentation model, as explained above in the context of FIG. 1. Step 306 then performs a “BOM out” of the order history to determine the raw materials (parts) used. BOM refers to a bill of materials which is a comprehensive list of parts (e.g., items, assemblies, subassemblies, intermediate assemblies, documents, drawings, and other materials) required to create a product. The BOM can be thought of as the recipe used to create a finished product, presented in a hierarchical format. Thus, to a BOM out means to take the BOM and identify the parts listed in the BOM. The parts are then classified under the demand segments in step 308.

In other words, collectively, steps 302 through 308 obtain the sales order history across demand segments defined by the given demand segmentation model, classify the sales orders based on the demand segments (e.g., a flag-based classification can be used), and find all parts used on the order by doing a BOM out of the orders in each demand segments. Classification can be performed by running a suitable algorithm, e.g., a multi-class classification algorithm. Not all parts need be considered. In a system, there will be critical components (for which there is frequent parts shortages) and non-critical components. Thus, some embodiments target the critical components while classifying the parts (e.g., classifications such as HDD, RAM module, motherboard, etc.).

Step 310 forecasts the consumption of parts in the targeted classified classes in each demand segment. In some embodiments, a random forest algorithm is used to provide the forecast. Based on the forecast, OEM knows the probable number of HDDs, RAM modules and motherboards it needs in a given time frame (e.g., next month, next quarter, etc.) within each demand segment. Linear regression techniques can be used in step 312 to smooth out the forecast generated in step 310.

In step 314, a supply segmentation is derived, e.g., by creating a supply segment (one to one correspondence) for each demand segment or by some other correspondence. Step 316 then soft allocates, for each supply segment, part of the incoming supply of raw material based on the forecasted demand percentage. Step 318 then hard allocates part of the incoming supply based on important (critical, high priority, high valued, etc.) transactional quotes and orders. Step 320 re-runs the soft allocation against transactional orders to make hard allocations (change a quantity of parts from a soft allocation to a hard allocation) if needed. Step 322 allows the inventory to stream from the supply segment from soft allocation. Step 324 derives one or more actions in case there is any predicted parts shortages in the soft allocation (e.g., notify OEM procurement system or team to obtain more inventory). It is to be appreciated that a parts shortage condition can be defined by a quantity in a given supply segment falling below a given quantity threshold or based on some other criteria.

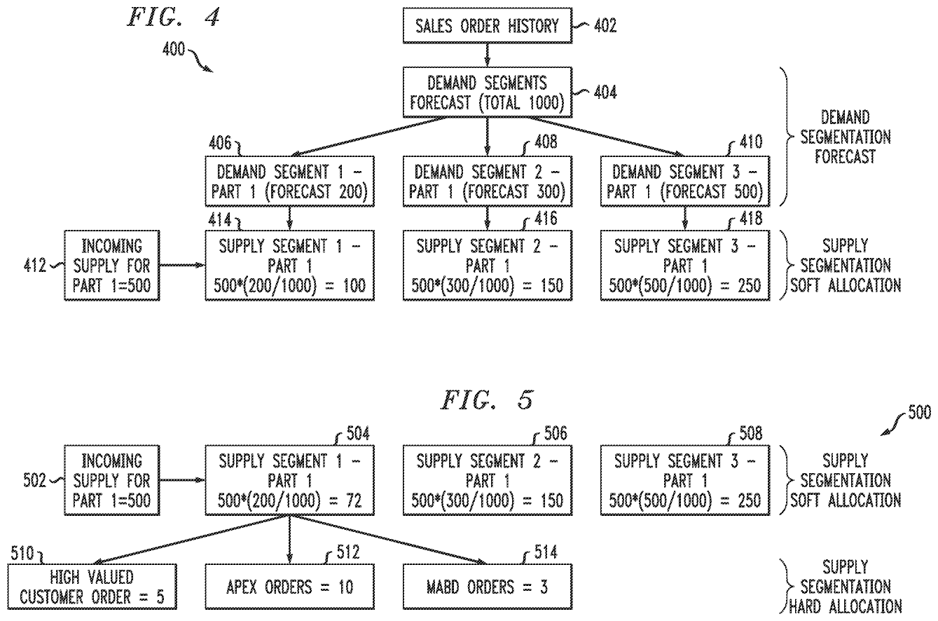

FIG. 4 illustrates an example 400 of soft allocation of inventory according to an illustrative embodiment, while FIG. 5 illustrates an example 500 of a hard allocation of inventory according to an illustrative embodiment.

More particularly, as shown in example 400 of FIG. 4, a sales order history 402 is input and a demand segment forecast 404 is created from the sales order history 402, as explained above. Assume the total demand forecast (forecast accumulated for each demand segment) is 1000 units for a given part (i.e., part 1). Blocks 406, 408 and 410 show the forecasts, respectively, for demand segments 1, 2 and 3, i.e., 200/1000 units (20% of total demand forecast) is forecasted for part 1 for demand segment 1, 300/1000 units (30% of total demand forecast) is forecasted for part 1 for demand segment 2, and 500/1000 units (50% of total demand forecast) is forecasted for part 1 for demand segment 3 (i.e., 200+300+500=1000). Then, for an input supply 412 of 500 units of part 1, blocks 414, 416 and 418 show supply segmentation soft allocation with 100 units (20% of 500 units) being soft allocated for supply segment 1 (corresponding to demand segment 1), 150 units (30% of 500 units) being soft allocated for supply segment 2 (corresponding to demand segment 2), and 250 units (50% of 500 units) being soft allocated for supply segment 3 (corresponding to demand segment 3).

Referring now to example 500 in FIG. 5, assume that existing/anticipated transactional orders have been run and now, for the supply segments 504, 506 and 508 which are the same as blocks 414, 416 and 418, a hard allocation of some of input supply 502 (same input supply as 412) is considered. As a result, assume that the soft (non-fixed) allocation for supply segment 1 (504) is adjusted from 100 units to 72 units such that certain quantities of part 1 are hard (fixed) allocated to a high valued customer order 510 (5 units), APEX orders 512 (10 units), and MABD orders 514 (3 units).

Then, new inventory coming from the supplier will be segmented based on this rule. According to the transactional order, the supply chain management methodology performs a re-allocation multiple times in a day and hard allocates and re-adjusts the soft allocation between the supply segments. In case of an anticipated parts shortage, the supply chain management methodology notifies the procurement team or system regarding the details of the projected shortage to enable the team to replenish the part as per the need.

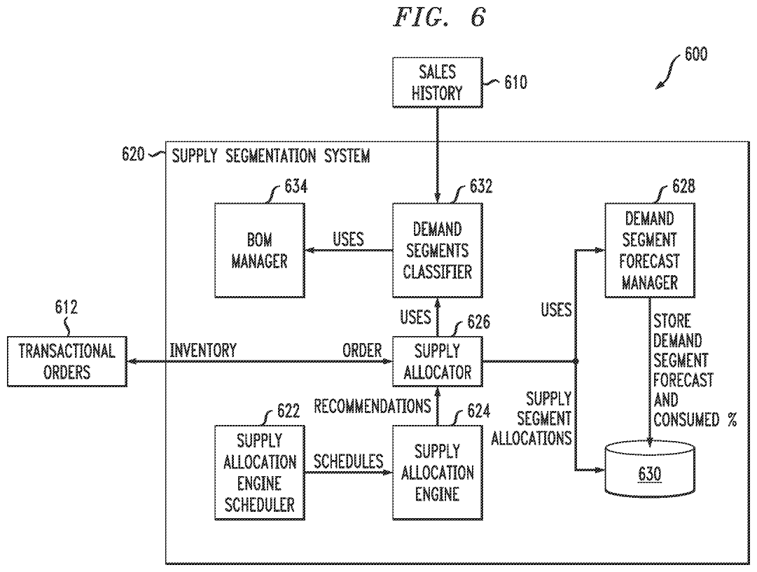

FIG. 6 illustrates a supply chain management system architecture 600 according to an illustrative embodiment. More particularly, supply chain management system architecture 600 is configured to perform steps/operations of FIGS. 1-5 and otherwise mentioned herein. As shown, supply chain management system architecture 600 depicts a sales history 610 and transactional orders 612 being input to a supply segmentation system 620. Supply segmentation system 620 comprises a supply allocation engine scheduler 622, a supply allocation engine 624, a supply allocator 626, a demand segment forecast manager 628, a storage unit 630, a demand segments classifier 632, and a BOM manager 634, operatively coupled as shown in FIG. 6. Unless otherwise specified, the components of FIG. 6 perform the steps/operations corresponding to their names consistent with the steps/operations of FIGS. 1-5.

More particularly, demand segments classifier 632 takes the total demand and first segregates it into different demand segments. Each order in each segment is BOM-ed out using BOM manager 634 to get the raw materials (parts) used in that order and system. Demand segments classifier 632 classifies parts into targeted categories (e.g., 1 TB HDD, 16 MB RAM, Motherboard XYZ, etc.) using a multi-class classification algorithm. By way of example only, the HDD category may contain several parts based on the supplier. The classification results are used by demand segment forecast manager 628 to forecast the consumption of raw materials (parts) based on the targeted categories using one or more artificial intelligence, machine learning or deep learning algorithms such as, but not limited to, random forest and linear regression. BOM manager 634 BOM-es out the order into respective raw materials used.

Supply allocation engine 624 creates the supply segments by starting with the existing raw material allocation based on the current incoming supply and back logs and allocates the soft allocation based on the demand segmentation and the percentage of forecasted consumption on each demand segment. Further, supply allocator 626 reads the current transactional orders and quotes (also materialized opportunities) to perform the hard allocation based on one or more of customer relationship, level of urgency from customer, quotes and MABDs, size of the anticipated orders, and types of the order. Still further, supply allocation engine scheduler 622 provides a scheduler that runs supply allocation engine 624 upon a change in the incoming supply or a transactional demand to re-allocate the soft allocation and create hard allocations as needed.

Accordingly, system architecture 600 implements a process called supply segmentation to segment the incoming supply and allocate the raw material inventory systematically for different types of demands based on the incoming supply and actual raw material consumption in different demand segments. Further, system architecture 600 implements a hybrid model of soft (non-fixed) allocation and hard (fixed) allocation for optimal raw material (supply) allocation and re-allocation. Still further, system architecture 600 pro-actively identifies the probable parts shortages and take necessary action to mitigate such shortages.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

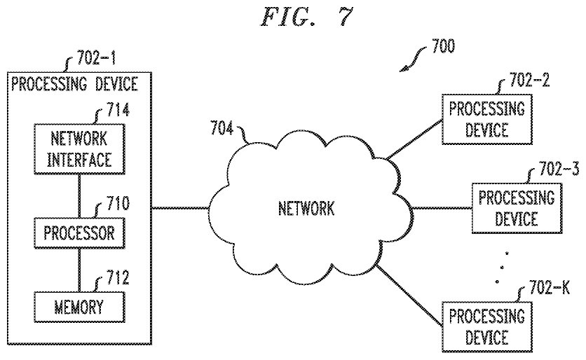

FIG. 7 depicts a processing platform 700 used to implement information processing systems/processes 100 through 600 depicted in FIGS. 1 through 6, respectively, according to an illustrative embodiment. More particularly, processing platform 700 is a processing platform on which a computing environment with functionalities described herein can be implemented.

The processing platform 700 in this embodiment comprises a plurality of processing devices, denoted 702-1, 702-2, 702-3, . . . 702-K, which communicate with one another over network(s) 704. It is to be appreciated that the methodologies described herein may be executed in one such processing device 702, or executed in a distributed manner across two or more such processing devices 702. It is to be further appreciated that a server, a client device, a computing device or any other processing platform element may be viewed as an example of what is more generally referred to herein as a “processing device.” As illustrated in FIG. 7, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 702 shown in FIG. 7. The network(s) 704 represent one or more communications networks that enable components to communicate and to transfer data therebetween, as well as to perform other functionalities described herein.

The processing device 702-1 in the processing platform 700 comprises a processor 710 coupled to a memory 712. The processor 710 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 710. Memory 712 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 712 may comprise electronic memory such as random-access memory (RAM), read-only memory (ROM) or other types of memory, in any combination. The one or more software programs when executed by a processing device such as the processing device 702-1 causes the device to perform functions associated with one or more of the components/steps of system/methodologies in FIGS. 1 through 6. One skilled in the art would be readily able to implement such software given the teachings provided herein. Other examples of processor-readable storage media embodying embodiments of the invention may include, for example, optical or magnetic disks.

Processing device 702-1 also includes network interface circuitry 714, which is used to interface the device with the networks 704 and other system components. Such circuitry may comprise conventional transceivers of a type well known in the art.

The other processing devices 702 (702-2, 702-3, . . . 702-K) of the processing platform 700 are assumed to be configured in a manner similar to that shown for computing device 702-1 in the figure.

The processing platform 700 shown in FIG. 7 may comprise additional known components such as batch processing systems, parallel processing systems, physical machines, virtual machines, virtual switches, storage volumes, etc. Again, the particular processing platform shown in this figure is presented by way of example only, and the system shown as 700 in FIG. 7 may include additional or alternative processing platforms, as well as numerous distinct processing platforms in any combination.

Also, numerous other arrangements of servers, clients, computers, storage devices or other components are possible in processing platform 700. Such components can communicate with other elements of the processing platform 700 over any type of network, such as a wide area network (WAN), a local area network (LAN), a satellite network, a telephone or cable network, or various portions or combinations of these and other types of networks.

Furthermore, it is to be appreciated that the processing platform 700 of FIG. 7 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 700 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-7 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

1. An apparatus comprising:
at least one processing device comprising a processor coupled to a memory, the at least one processing device, when executing program code, is configured to:
receive a plurality of transactional orders for equipment;
classify the plurality of transactional orders into a plurality of demand segments by executing at least a multi-class classification machine learning algorithm;
forecast, in respective ones of the plurality of demand segments, a demand for material needed to manufacture the equipment via a supply chain, wherein the forecasting is performed by executing at least a random forest machine learning algorithm;
define respective ones of a plurality of supply segments for the respective ones of the plurality of demand segments to address the forecasted demand for the material needed to manufacture the equipment via the supply chain;
allocate supplied material across the respective ones of the plurality of supply segments wherein a first portion of the supplied material is allocated into a non-fixed condition based at least in part on the forecasted demand and a second portion of the supplied material is allocated into a fixed condition based at least in part on one or more priority factors;
responsive at least in part to one of a change in availability of the supplied material and to one or more parameters of the forecasted demand, cause execution of an allocation scheduler engine configured to re-allocate at least some of the supplied material from the non-fixed condition within at least one given supply segment to the fixed condition within the at least one given supply segment, wherein an amount of the at least some of the supplied material in the non-fixed condition is reduced within the at least one given supply segment to accommodate the re-allocation; and
generate and transmit to a procurement system one or more notifications corresponding to the re-allocation when the supplied material allocated in one or more of the plurality of supply segments falls below a given threshold quantity.

2. The apparatus of claim 1, wherein the at least one processing device, when executing program code, is further configured to re-allocate some of the first portion of the supplied material to the second portion of the supplied material based on one or more transactional orders.

3. The apparatus of claim 1, wherein the at least one processing device, when executing program code, is further configured to satisfy the forecasted demand for the material needed to manufacture the equipment from the first portion of the supplied material.

4. (canceled)

5. The apparatus of claim 1, wherein the at least one processing device, when executing program code, is further configured to respectively assign a plurality of forecasted demand percentages to the plurality of supply segments.

6. The apparatus of claim 1, wherein the plurality of supply segments are defined based on one or more of: historical consumption of the material needed to manufacture the equipment in different demand segments; a customer relationship; a level of customer urgency; a quote; a delivery date; a size of an order; and a type of an order.

7. (canceled)

8. A method comprising:
receiving a plurality of transactional orders for equipment;
classifying the plurality of transactional orders into a plurality of demand segments by executing at least a multi-class classification machine learning algorithm;
forecasting, in respective ones of the plurality of demand segments, a demand for material needed to manufacture the equipment via a supply chain, wherein the forecasting is performed by executing at least a random forest machine learning algorithm;
defining respective ones of a plurality of supply segments for the respective ones of the plurality of demand segments to address the forecasted demand for the material needed to manufacture the equipment via the supply chain;
allocating supplied material across the plurality of supply segments wherein a first portion of the supplied material is allocated into a non-fixed condition based at least in part on the forecasted demand and a second portion of the supplied material is allocated into a fixed condition based at least in part on one or more priority factors;
responsive at least in part to one of a change in availability of the supplied material and to one or more parameters of the forecasted demand, causing execution of an allocation scheduler engine configured to re-allocate at least some of the supplied material from the non-fixed condition within at least one given supply segment to the fixed condition within the at least one given supply segment, wherein an amount of the at least some of the supplied material in the non-fixed condition is reduced within the at least one given supply segment to accommodate the re-allocation; and
generating and transmitting to a procurement system one or more notifications corresponding to the re-allocation when the supplied material allocated in one or more of the plurality of supply segments falls below a given threshold quantity;
wherein the steps of the method are performed by at least one processor comprising memory.

9. The method of claim 8, further comprising re-allocating some of the first portion of the supplied material to the second portion of the supplied material based on one or more transactional orders.

10. The method of claim 8, further comprising satisfying the forecasted demand for the material needed to manufacture the equipment from the first portion of the supplied material.

11. (canceled)

12. The method of claim 8, further comprising respectively assigning a plurality of forecasted demand percentages to the plurality of supply segments.

13. The method of claim 8, wherein the plurality of supply segments are defined based on one or more of: historical consumption of the material needed to manufacture the equipment in different demand segments; a customer relationship; a level of customer urgency; a quote; a delivery date; a size of an order; and a type of an order.

14. (canceled)

15. A computer program product comprising a non-transitory processor-readable storage medium having stored therein program code of one or more software programs, wherein the program code when executed by at least one processing device causes the at least one processing device to:
receive a plurality of transactional orders for equipment;
classify the plurality of transactional orders into a plurality of demand segments by executing at least a multi-class classification machine learning algorithm;
forecast, in respective ones of the plurality of demand segments, a demand for material needed to manufacture the equipment via a supply chain, wherein the forecasting is performed by executing at least a random forest machine learning algorithm;
define respective ones of a plurality of supply segments for the respective ones of the plurality of demand segments to address the forecasted demand for the material needed to manufacture the equipment via the supply chain;
allocate supplied material across the plurality of supply segments wherein a first portion of the supplied material is allocated into a non-fixed condition based at least in part on the forecasted demand and a second portion of the supplied material is allocated into a fixed condition based at least in part on one or more priority factors;
responsive at least in part to one of a change in availability of the supplied material and to one or more parameters of the forecasted demand, cause execution of an allocation scheduler engine configured to re-allocate at least some of the supplied material from the non-fixed condition within at least one given supply segment to the fixed condition within the at least one given supply segment, wherein an amount of the at least some of the supplied material in the non-fixed condition is reduced within the at least one given supply segment to accommodate the re-allocation; and
generate and transmit to a procurement system one or more notifications corresponding to the re-allocation when the supplied material allocated in one or more of the plurality of supply segments falls below a given threshold quantity.

16. The computer program product of claim 15, wherein the program code further causes the at least one processing device to re-allocate some of the first portion of the supplied material to the second portion of the supplied material based on one or more transactional orders.

17. The computer program product of claim 15, wherein the program code further causes the at least one processing device to satisfy the forecasted demand for the material needed to manufacture the equipment from the first portion of the supplied material.

18. (canceled)

19. The computer program product of claim 15, wherein the program code further causes the at least one processing device to respectively assign a plurality of forecasted demand percentages to the plurality of supply segments.

20. The computer program product of claim 15, wherein the plurality of supply segments are defined based on one or more of: historical consumption of the material needed to manufacture the equipment in different demand segments; a customer relationship; a level of customer urgency; a quote; a delivery date; a size of an order; a type of an order; and a plurality of demand segments.

21. The computer product of claim 15, wherein the program code further causes the at least one processing device to identify the material needed to manufacture the equipment in the respective ones of the plurality of demand segments for respective ones of the plurality of transactional orders.

22. The computer product of claim 15, wherein the program code further causes the at least one processing device to smooth the forecasted demand using a linear regression technique.

23. The apparatus of claim 1, wherein the at least one processing device, when executing program code, is further configured to identify the material needed to manufacture the equipment in the respective ones of the plurality of demand segments for respective ones of the plurality of transactional orders.

24. The apparatus of claim 1, wherein the at least one processing device, when executing program code, is further configured to smooth the forecasted demand using a linear regression technique.

25. The method of claim 8, further comprising smoothing the forecasted demand using a linear regression technique.
